(19) United States
(12) Patent Application Publication
(10) Pub. No.: US 2026/0282034 A1
(43) Pub. Date: Sep. 17, 2026

(54) DCI TRIGGERED SSB ADAPTATION

(71) Applicant: Samsung Electronics Co., Ltd., Suwon-si (KR)

(72) Inventor: Hongbo Si, Allen, TX (US)

(21) Appl. No.: 19/546,228

(22) Filed: Feb. 20, 2026

Related U.S. Application Data
(60) Provisional application No. 63/770,628, filed on Mar. 12, 2025.
(60) Provisional application No. 63/796,066, filed on Apr. 28, 2025.
(60) Provisional application No. 63/813,301, filed on May 28, 2025.

(51) Int. Cl. H04W 72/232; H04W 56/00

(52) U.S. Cl. CPC H04W 72/232; H04W 56/001

(57) ABSTRACT

Apparatuses and methods for downlink control information (DCI) triggered synchronization signal block (SSB) adaptation. A method of a user equipment (UE) in a wireless communication system includes receiving a set of higher layer parameters and receiving a physical downlink control channel (PDCCH) providing a DCI format in a slot with index m of a first serving cell and on an active downlink bandwidth part (BWP) of the first serving cell. The method further includes determining a change of a periodicity for the SS/PBCH blocks, based on an indication of the periodicity for the SS/PBCH blocks in the DCI format, determining that transmission of the SS/PBCH blocks according to the indicated periodicity on a second serving cell starts from a slot on the second serving cell, based on a first transmitted SS/PBCH block index, and receiving the SS/PBCH blocks.

### CROSS-REFERENCE TO RELATED AND CLAIM OF PRIORITY

The present application claims priority under 35 U.S.C. § 119(e) to U.S. Provisional Patent Application No. 63/770,628 filed on Mar. 12, 2025; U.S. Provisional Patent Application No. 63/796,066 filed on Apr. 28, 2025; and Provisional Patent Application No. 63/813,301 filed on May 28, 2025, which are hereby incorporated by reference in their entirety.

### TECHNICAL FIELD

The present disclosure relates generally to wireless communication systems and, more specifically, the present disclosure is related to a method and apparatus of downlink control information (DCI) triggered synchronization signal and/or physical broadcast channel block (SS/PBCH block or SSB) adaptation.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to method and apparatus of DCI triggered SSB adaptation.

In one embodiment, a user equipment (UE) is provided. The UE includes a user equipment (UE) in a wireless communication system is provided. The UE includes a transceiver configured to receive a set of higher layer parameters and receive a physical downlink control channel (PDCCH) providing a DCI format in a slot with index m of a first serving cell and on an active downlink bandwidth part (BWP) of the first serving cell. The set of higher layer parameters includes a first periodicity for synchronization signals and physical broadcast channel (SS/PBCH) blocks and a set of additional periodicities for the SS/PBCH blocks. The UE further includes a processor operably coupled to the transceiver. The processor configured to determine a change of a periodicity for the SS/PBCH blocks, based on an indication of the periodicity for the SS/PBCH blocks in the DCI format and determine that transmission of the SS/PBCH blocks according to the indicated periodicity on a second serving cell starts from a slot on the second serving cell, based on a first transmitted SS/PBCH block index. The transceiver is further configured to receive the SS/PBCH blocks.

In another embodiment, a base station (BS) is provided. The BS includes a method of a UE in a wireless communication system is provided. The method includes receiving a set of higher layer parameters and receiving a PDCCH providing a DCI format in a slot with index m of a first serving cell and on an active BWP of the first serving cell. The set of higher layer parameters includes a first periodicity for SS/PBCH blocks and a set of additional periodicities for the SS/PBCH blocks. The method further includes determining a change of a periodicity for the SS/PBCH blocks, based on an indication of the periodicity for the SS/PBCH blocks in the DCI format, determining that transmission of the SS/PBCH blocks according to the indicated periodicity on a second serving cell starts from a slot on the second serving cell, based on a first transmitted SS/PBCH block index, and receiving the SS/PBCH blocks.

In yet another embodiment, a method performed by a user equipment is provided. The method includes a base station (BS) in a wireless communication system is provided. The BS includes a transceiver configured to transmit a set of higher layer parameters and transmit a PDCCH providing a DCI format in a slot with index m of a first serving cell and on an active downlink BWP of the first serving cell. The set of higher layer parameters includes a first periodicity for SS/PBCH blocks and a set of additional periodicities for the SS/PBCH blocks. The BS includes a processor operably coupled to the transceiver. The processor is configured to determine a change of a periodicity for the SS/PBCH blocks, based on an indication of the periodicity for the SS/PBCH blocks in the DCI format and determine that transmission of the SS/PBCH blocks according to the indicated periodicity on a second serving cell starts from a slot on the second serving cell, based on a first transmitted SS/PBCH block index. The transceiver is further configured to transmit the SS/PBCH blocks.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station (BS) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates example scenarios for using the DCI format according to embodiments of the present disclosure;

FIG. 6 illustrates an example method performed by a UE in a wireless communication system according to embodiments of the present disclosure; and

FIG. 7 illustrates another example method performed by a UE in a wireless communication system according to embodiments of the present disclosure.

### DETAILED DESCRIPTION

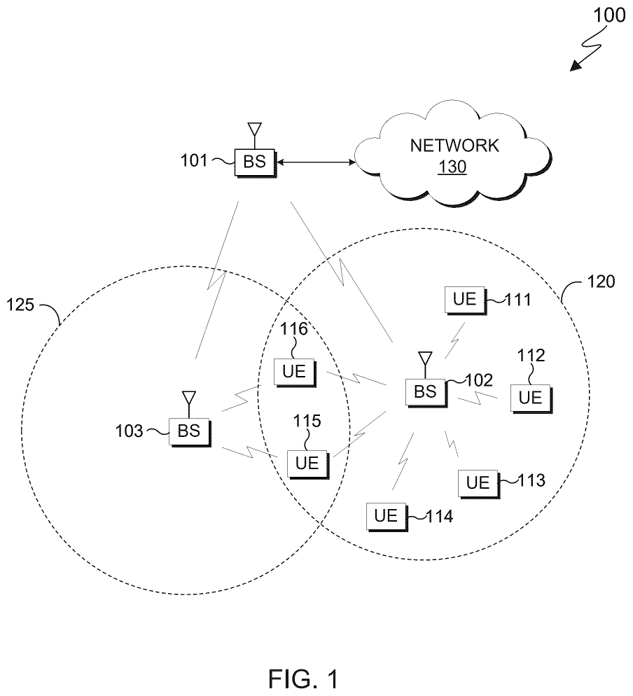

FIGS. 1-7 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v17.1.0, “NR; Physical channels and modulation” (herein, “REF 1”); 3GPP TS 38.212 v17.1.0, “NR; Multiplexing and channel coding” (herein, “REF 2”); 3GPP TS 38.213 v17.1.0, “NR; Physical layer procedures for control” (herein, “REF 3”); 3GPP TS 38.214 v17.1.0, “NR; Physical layer procedures for data” (herein, “REF 4”); and 3GPP TS 38.331 v17.1.0, “NR; Radio Resource Control (RRC) protocol specification” (herein, “REF 5”).

FIGS. 1-3 below describe various embodiments implemented in wireless communications systems and with the use of orthogonal frequency division multiplexing (OFDM) or orthogonal frequency division multiple access (OFDMA) communication techniques. However, this disclosure can be extended to other OFDM-based transmission waveforms or multiple access schemes such as filtered OFDM (F-OFDM). The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, eNB, gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for DCI triggered SSB adaptation. In certain embodiments, one or more of the BSs 101-103 include circuitry, programing, or a combination thereof to enable DCI triggered SSB adaptation.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

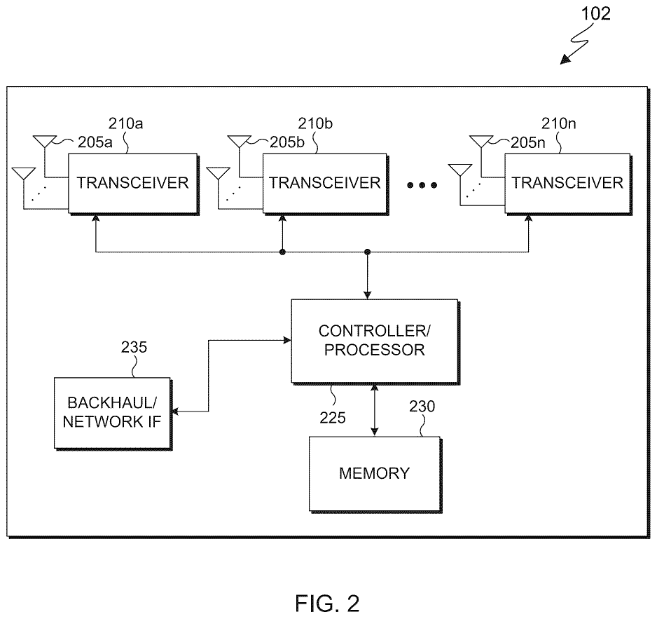

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for enabling DCI triggered SSB adaptation. Any of a wide variety of other functions could be supported in the BS 102 by the controller/processor 225.

The controller/processor 225 is also capable of executing programs and other processes resident in the memory 230, such as processes to enable DCI triggered SSB adaptation. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

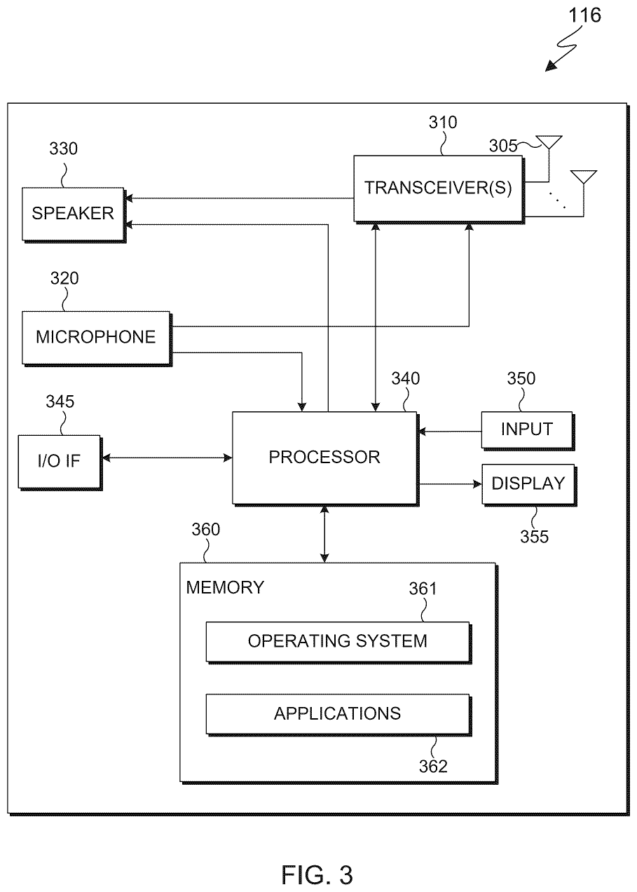

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for DCI triggered SSB adaptation as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

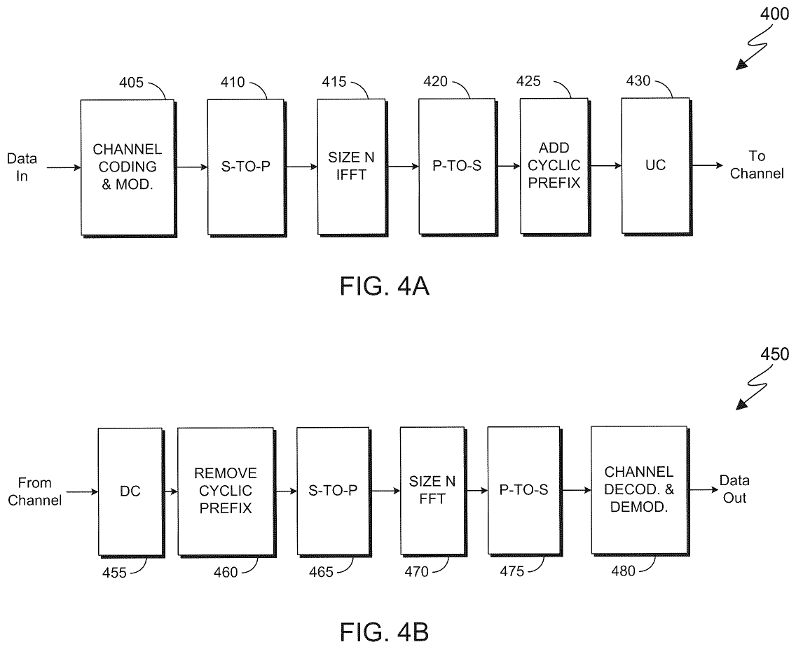

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting DCI triggered SSB adaptation as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In legacy NR, a cell can be configured with SS/PBCH block (SSB) transmissions, wherein the transmissions are in a periodic manner and the periodicity of the SSB is configured by the BS. For initial access procedure, e.g., the UE is not provided with the configuration of the periodicity of the SSB yet, the UE can assume the periodicity for the SSB transmission is 20 ms. After initial access procedure, the UE can acquire the configuration of the periodicity for the SSB transmission, and assume the SSB transmission following the configured periodicity. The UE may not expect the periodicity for the SSB transmission varies if no reconfiguration of the parameter is provided to the UE.

The periodic transmission of SSB using a configured periodicity may result in high energy consumption from the network perspective. For example, when the data traffic is high or mobility of the UE is fast, the network may configure a short periodicity for the SSB transmission such that the UE may maintain good synchronization and perform good measurement in order to receive high amount of data and to adapt with the mobility. However, when the data traffic is low or mobility of the UE is slow, the network may not need to configure a short periodicity for the SSB transmission, and the network can save energy by configuring a long periodicity for the SSB transmission. In the legacy wireless system, the reconfiguration of the periodicity for the SSB transmission can only be performed by RRC reconfiguration, which is not frequency and has long delay for UE processing. This disclosure is targeting for dynamic adaptation of the periodicity for the SSB transmission, which can be triggered a DCI format (e.g., carried by a PDCCH).

For one example, the adaptation of the periodicity for the SSB transmission can be applicable for RRC_CONNECTED mode.

For another example, the adaptation of the periodicity for the SSB transmission can be applicable for RRC_IDLE mode.

For yet another example, the adaptation of the periodicity for the SSB transmission can be applicable for RRC_INACTIVE mode.

For one example, the adaptation of the periodicity for the SSB transmission can be applicable for a primary cell (PCell).

For another example, the adaptation of the periodicity for the SSB transmission can be applicable for a secondary cell (SCell).

For yet another example, the adaptation of the periodicity for the SSB transmission can be applicable for a primary secondary cell (PSCell).

For one example, the adaptation of the periodicity for the SSB transmission can be applicable for SSB as cell-defining SSB (e.g., with associated SIB1 transmission).

For another example, the adaptation of the periodicity for the SSB transmission can be applicable for SSB as non-cell-defining SSB (e.g., without associated SIB1 transmission).

For one example, the adaptation of the periodicity for the SSB transmission can be applicable for SSB located at a frequency layer given by a synchronization raster entry.

For another example, the adaptation of the periodicity for the SSB transmission can be applicable for SSB located at a frequency layer not given by a synchronization raster entry.

The present disclosure focuses on adaptation of SSB transmission based on a DCI format. More precisely, the following aspects are included in one or more embodiments of the present disclosure:
DCI format for the adaptation of SSB transmission
Scenarios for applying the DCI format
UE procedure for monitoring the DCI format
   Serving cell to monitor the DCI format
   Time duration to monitor the DCI format
   Validation time for the indication in the DCI format
   Timeline for applying the indication in the DCI format
   Flow chart of an example method performed by the UE

In the present disclosure, a DCI format for SSB adaptation is provided.

In one embodiment, a configuration for SS/PBCH block (SSB) transmission or an SSB-based measurement time configuration (SMTC) can be adapted based on a DCI format. For one example, the DCI format can be a DCI format 2_9. For one example, the DCI format can be associated with a CRC scrambled by a cellDTRX-RNTI (e.g., a RNTI for cell discontinuous transmission and/or reception). For another example, the DCI format can be associated with a CRC scrambled by a radio network temporary identifier (RNTI) different from the cellDTRX-RNTI, e.g., ssbAdaptation-RNTI (a RNTI dedicated for adaptation of SSB).

For one example, the information carried by the DCI format can be formulated as a number N of blocks, e.g., block number 1, block number 2, . . . , block number N.
For one further implementation, the starting position of a block can be configured by a higher layer parameter (e.g., positionInDCI-cellDTRX, or positionInDCI-ssbAdaptation) for a UE.
For another further implementation, a block can be associated with a serving cell (e.g., a SCell), or a group of serving cell (e.g., SCell).
For yet another further implementation, one or more blocks can be configured for a UE.
For yet another further implementation, the size of the DCI format can be configured by a higher layer parameter.
For yet another further implementation, each block can include at least one of the following fields:
   Cell DTX/DRX indication
   NES mode indication
   SSB configuration (e.g., periodicity) indication

For another example, the information carried by the DCI format can be formulated as a number N+M of blocks, e.g., block number 1, block number 2, . . . , block number N, block number N+1, . . . , block number N+M.
For one further implementation, the starting position of a block within the first N blocks (e.g., block number 1 to block number N) can be configured by a first higher layer parameter (e.g., positionInDCI-cellDTRX) for a UE.
For another further implementation, the starting position of a block within the second M blocks (e.g., block number N+1 to block number N+M) can be configured by a second higher layer parameter (e.g., positionInDCI-ssbAdaptation) for the UE.
For yet another further implementation, a block within the first N blocks (e.g., block number 1 to block number N) can be associated with a first serving cell, or a first group of serving cell.
For yet another further implementation, a block within the second M blocks (e.g., block number N+1 to block number N+M) can be associated with a second serving cell, or a second group of serving cell.
For yet another further implementation, a block within the second M blocks (e.g., block number N+1 to block number N+M) can be associated with a SCell.
For yet another further implementation, one or more blocks can be configured for a UE.
For yet another further implementation, the size of the DCI format can be configured by a higher layer parameter.
For yet another further implementation, each block within the first N blocks (e.g., block number 1 to block number N) can include at least one of the following fields:
   Cell DTX/DRX indication
   NES mode indication
For yet another further implementation, each block within the second M blocks (e.g., block number N+1 to block number N+M) can include at least one of the following fields:
   SSB configuration (e.g., periodicity) indication
For yet another further implementation, N can be equal to M.
For yet another further implementation, N can be equal to M+1.

For one further implementation of above example, a bit-width of the field “SSB configuration (e.g., periodicity) indication” (e.g., which is same as the block length if the block only has one field as the field of “SSB configuration (e.g., periodicity) indication”) can be determined as 1.
For one instance, when “SSB configuration (e.g., periodicity) indication”=a first value (e.g., “0”, or “1”), a UE can apply a first SSB configuration (e.g., periodicity) (e.g., a default SSB configuration, or a non-additional SSB configuration), and when “SSB configuration (e.g., periodicity) indication”=a second value (e.g., “1”, or “0”), a UE can apply a second SSB configuration (e.g., periodicity) (e.g., a non-default SSB configuration, or an additional SSB configuration).

For another further implementation of above example, a bit-width of the field “SSB configuration (e.g., periodicity) indication” (e.g., which is same as the block length if the block only has one field as the field of “SSB configuration (e.g., periodicity) indication”) can be determined as 1, if a higher layer parameter (e.g., ssbAdaptationActivation or cellDTX-DRX-L1activation) is provided; and determined as 0, otherwise.
For one instance, when “SSB configuration (e.g., periodicity) indication”=a first value (e.g., “0”, or “1”), a UE can apply a first SSB configuration (e.g., periodicity) (e.g., a default SSB configuration, or a non-additional SSB configuration), and when “SSB configuration (e.g., periodicity) indication”=a second value (e.g., “1”, or “0”), a UE can apply a second SSB configuration (e.g., periodicity) (e.g., a non-default SSB configuration, or an additional SSB configuration).
For another instance, when the higher layer parameter is not provided (e.g., the field “SSB configuration (e.g., periodicity) indication” is not included in the DCI format), a UE can apply a first SSB configuration (e.g., periodicity) (e.g., a default SSB configuration, or a non-additional SSB configuration).
For one further implementation, the default/non-additional periodicity can be larger than (or no less than) the additional/non-default periodicity.
For another further implementation, the default/non-additional periodicity can be not equal to the additional/non-default periodicity.

For yet another further implementation of above example, a bit-width of the field “SSB configuration (e.g., periodicity) indication” (e.g., which is same as the block length if the block only has one field as the field of “SSB configuration (e.g., periodicity) indication”) can be determined as ceil(log 2(1+K)) bits.
For one instance, K can be fixed, which corresponds to a number of additional SSB configuration(s) (e.g., periodicities), such as K=0, K=1, or K=2.
For another instance, K can be configured by the BS, which corresponds to a number of additional SSB configuration(s) (e.g., periodicities), such as the candidate values of K can be from {0, 1}, or {0, 1, 2}.
For yet another instance, K can be determined based on the configuration (e.g., additionalSSB-Periodicity) of additional SSB configuration(s) (e.g., periodicities), which corresponds to a number of additional SSB configuration(s) (e.g., periodicities). When no configuration of additional SSB configuration(s) (e.g., periodicities) is provided, K=0. The maximum number of additional SSB configuration(s) (e.g., periodicities) (e.g., maximum value of K) can be 1 or 2.
For yet another instance, when “SSB configuration (e.g., periodicity) indication”=a first value (e.g., “0”), a UE can apply a first SSB configuration (e.g., periodicity) (e.g., a default SSB configuration, or a non-additional SSB configuration). When “SSB configuration (e.g., periodicity) indication”=a second value from a set of values not including the first value (e.g., “1”), a UE can apply a second SSB configuration (e.g., periodicity) correspondingly (e.g., a first non-default SSB configuration, or a first additional SSB configuration). When “SSB configuration (e.g., periodicity) indication”=a third value from a set of values not including the first value (e.g., “2”), a UE can apply a third SSB configuration (e.g., periodicity) correspondingly (e.g., a second non-default SSB configuration, or a second additional SSB configuration).
For one further implementation, the default/non-additional periodicity can be larger than (or no less than) the additional/non-default periodicity/periodicities.
For another further implementation, the default/non-additional periodicity can be not equal to the additional/non-default periodicity/periodicities.
For yet another further implementation, when K>1, at least first additional/non-default periodicity is larger than the default/non-additional periodicity, and at least second additional/non-default periodicity is smaller than the default/non-additional periodicity.

For yet another further implementation of above example, a bit-width of the field “SSB configuration (e.g., periodicity) indication” (e.g., which is same as the block length if the block only has one field as the field of “SSB configuration (e.g., periodicity) indication”) can be determined as ceil(log 2(1+K)) bits, if a higher layer parameter (e.g., additionalSSB-Periodicity, or ssbAdaptationActivation, or cellDTX-DRX-L1activation) is provided; and determined as 0, otherwise.
For one instance, K can be fixed, which corresponds to a number of additional SSB configuration(s) (e.g., periodicities), such as K=0, K=1, or K=2.
For another instance, K can be configured by the BS, which corresponds to a number of additional SSB configuration(s) (e.g., periodicities), such as the candidate values of K can be from {0, 1}, or {0, 1, 2}.
For yet another instance, K can be determined based on the configuration (e.g., additionalSSB-Periodicity) of additional SSB configuration(s) (e.g., periodicities), which corresponds to a number of additional SSB configuration(s) (e.g., periodicities). When no configuration of additional SSB configuration(s) (e.g., periodicities) is provided, K=0. The maximum number of additional SSB configuration(s) (e.g., periodicities) (e.g., maximum value of K) can be 1 or 2.
For yet another instance, when “SSB configuration (e.g., periodicity) indication”=a first value (e.g., “0” or “00”), a UE can apply a first SSB configuration (e.g., periodicity) (e.g., a default SSB configuration, or a non-additional SSB configuration). When “SSB configuration (e.g., periodicity) indication”=a second value (e.g., “1” or “01”), a UE can apply a second SSB configuration (e.g., periodicity) correspondingly (e.g., a first non-default SSB configuration, or a first additional SSB configuration). When “SSB configuration (e.g., periodicity) indication”=a third value (e.g., “2” or “10”), a UE can apply a third SSB configuration (e.g., periodicity) correspondingly (e.g., a second non-default SSB configuration (e.g., periodicity), or a second additional SSB configuration (e.g., periodicity)).
For yet another instance, when the higher layer parameter is not provided (e.g., the field “SSB configuration (e.g., periodicity) indication” is not included in the DCI format), a UE can apply a first SSB configuration (e.g., periodicity) (e.g., a default SSB configuration, or a non-additional SSB configuration).
For one further implementation, the default/non-additional periodicity can be larger than (or no less than) the additional/non-default periodicity/periodicities.
For another further implementation, the default/non-additional periodicity can be not equal to the additional/non-default periodicity/periodicities.
For yet another further implementation, when K>1, at least a first additional/non-default periodicity is larger than the default/non-additional periodicity, and at least a second additional/non-default periodicity is smaller than the default/non-additional periodicity.
For yet another further implementation, the default SSB configuration (e.g., periodicity) or the non-additional SSB configuration (e.g., periodicity) can be provided by ssb-periodicityServingCell (e.g., in servingCellConfigCommon).

For one further implementation of above example, the default or non-additional SSB configuration (e.g., periodicity) can be provided by a first higher layer parameter, and/or the non-default or additional SSB configuration(s) (e.g., periodicities) can be provided by a second higher layer parameter.

For another further implementation of above example, the default or non-additional SSB configuration (e.g., periodicity) can be determined as a first configuration (e.g., periodicity) within the set of configurations (e.g., periodicities) provided by higher layer parameter, and/or the non-default or additional SSB configuration(s) (e.g., periodicities) determined as the remaining configuration(s) (e.g., periodicities) within the set of configurations (e.g., periodicities) provided by higher layer parameter.

In the present disclosure, scenarios for using the DCI format are provided.

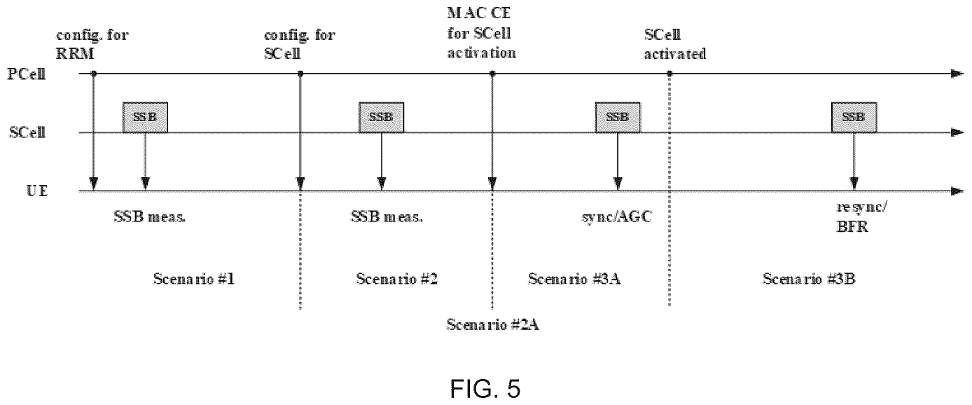

FIG. 5 illustrates example scenarios for using the DCI format according to embodiments of the present disclosure. For example, the scenarios can be implemented by any of the BS 101-103 of FIG. 1, such as BS 102 of FIG. 2. Further, the scenarios can be supported by any of the UEs 111-116 of FIG. 1, such as UE 116 of FIG. 3. These examples are for illustration only and other embodiments can be used without departing from the scope of the present disclosure.

In one embodiment, a BS may transmit and/or a UE may receive the DCI format for the SS/PBCH block adaptation for at least one of the following scenarios (e.g., at least from a UE perspective):
Scenario 1: before a SCell is configured. For instance, the UE has configuration for measurement on a cell before receiving a configuration for the cell being a SCell, e.g., the UE may not be provided with the configuration of additional/non-default SSB configuration (e.g., periodicity), or not be provided with the configuration of the starting position (e.g., positionInDCI-ssbAdaptation) of a block within the second M blocks (e.g., block number N+1 to block number N+M).
Scenario 2: after a SCell is configured and not activated, and before receiving a MAC CE indicating SCell activation. For instance, the UE has been provided with the configuration of additional/non-default SSB configuration (e.g., periodicity), or has been provided with the configuration of the starting position (e.g., positionInDCI-ssbAdaptation) of a block within the second M blocks (e.g., block number N+1 to block number N+M), but has not received the MAC CE for SCell activation yet.
Scenario 2A: when receiving a MAC CE indicating SCell activation.
Scenario 3A: after receiving the MAC CE indicating SCell activation and before the SCell is activated.
Scenario 3B: the SCell is activated.

For one example, from a BS perspective, the BS can transmit the DCI format in any of the listed scenarios.

For another example, from a BS perspective, the BS may not transmit the DCI in Scenario 1, e.g., if at least one UE may receive the DCI format is in Scenario 1 or at least one UE is configured to monitor the DCI format in Scenario 1, the BS may not transmit the DCI format.

For yet another example, from a BS perspective, the BS may not transmit the DCI in Scenario 2, e.g., if at least one UE may receive the DCI format is in Scenario 2 or at least one UE is configured to monitor the DCI format in Scenario 2, the BS may not transmit the DCI format.

For yet another example, from a BS perspective, the BS may not transmit the DCI in Scenario 2A, e.g., if at least one UE may receive the DCI format is in Scenario 2A or at least one UE is configured to monitor the DCI format in Scenario 2A, the BS may not transmit the DCI format.

For yet another example, from a BS perspective, the BS may not transmit the DCI in Scenario 3A, e.g., if at least one UE may receive the DCI format is in Scenario 3A or at least one UE is configured to monitor the DCI format in Scenario 3A, the BS may not transmit the DCI format.

For yet another example, from a BS perspective, the BS may not transmit the DCI in Scenario 3B, e.g., if at least one UE may receive the DCI format is in Scenario 3B or at least one UE is configured to monitor the DCI format in Scenario 3B, the BS may not transmit the DCI format.

For one example, from a UE perspective, the UE can receive the DCI format in any of the listed scenarios, or the UE can be configured to monitor the DCI format in any of the listed scenarios. For instance, after the UE receives the DCI format, the UE applies the indicated configuration for the corresponding serving cell (group).

For another example, from a UE perspective, the UE may not be configured to monitor the DCI format, or the UE is configured but may not need to monitor the DCI format, or the UE could be configured to monitor/receive the DCI format but can ignore or may not need to decode or may not be able to know the indication on SSB adaptation in the DCI formation, when the UE is in Scenario 1, e.g., the adaptation is applicable after the UE receives the configuration of the SCell.
For one further implementation, the UE can apply the current (or existing, or activated, or applied) configuration (e.g., periodicity) for the SSB to perform measurement (e.g., L1 and/or L3 measurement).
For another further implementation, the UE can apply the default (or non-additional) configuration (e.g., periodicity) for the SSB to perform measurement (e.g., L1 and/or L3 measurement).
For yet another further implementation, the UE can apply the current (or existing, or activated, or applied) configuration (e.g., periodicity) of the SMTC to perform measurement (e.g., L1 and/or L3 measurement).
For yet another further implementation, the UE can apply the default (or non-additional) configuration (e.g., periodicity) of the SMTC to perform measurement (e.g., L1 and/or L3 measurement).

For yet another example, from a UE perspective, the UE may not be configured to monitor the DCI format, or the UE is configured but may not need to monitor the DCI format, or the UE could be configured to monitor/receive the DCI format but can ignore the indication on SSB adaptation in the DCI formation, when the UE is in Scenario 2.
For one further implementation, the UE can apply the current (or existing, or activated, or applied) configuration (e.g., periodicity) for the SSB to perform measurement (e.g., L1 and/or L3 measurement).
For another further implementation, the UE can apply the default (or non-additional) configuration (e.g., periodicity) for the SSB to perform measurement (e.g., L1 and/or L3 measurement).
For yet another further implementation, the UE can apply the current (or existing, or activated, or applied) configuration (e.g., periodicity) of the SMTC to perform measurement (e.g., L1 and/or L3 measurement).
For yet another further implementation, the UE can apply the default (or non-additional) configuration (e.g., periodicity) of the SMTC to perform measurement (e.g., L1 and/or L3 measurement).

For yet another example, from a UE perspective, the UE may not be configured to monitor the DCI format, or the UE is configured but may not need to monitor the DCI format, or the UE could be configured to monitor/receive the DCI format but can ignore the indication on SSB adaptation in the DCI formation, when the UE is in Scenario 2A.
For one further implementation, the UE can apply the current (or existing, or activated, or applied) configuration (e.g., periodicity) for the SSB to perform measurement (e.g., L1 and/or L3 measurement).
For another further implementation, the UE can apply the default (or non-additional) configuration (e.g., periodicity) for the SSB to perform measurement (e.g., L1 and/or L3 measurement).
For yet another further implementation, the UE can apply the current (or existing, or activated, or applied) configuration (e.g., periodicity) of the SMTC to perform measurement (e.g., L1 and/or L3 measurement).
For yet another further implementation, the UE can apply the default (or non-additional) configuration (e.g., periodicity) of the SMTC to perform measurement (e.g., L1 and/or L3 measurement).

For yet another example, from a UE perspective, the UE may not be configured to monitor the DCI format, or the UE is configured but may not need to monitor the DCI format, or the UE could be configured to monitor/receive the DCI format but can ignore the indication on SSB adaptation in the DCI formation, when the UE is in Scenario 3A.
For one further implementation, the UE can apply the current (or existing, or activated, or applied) configuration (e.g., periodicity) for the SSB to perform measurement (e.g., L1 and/or L3 measurement).
For another further implementation, the UE can apply the default (or non-additional) configuration (e.g., periodicity) for the SSB to perform measurement (e.g., L1 and/or L3 measurement).
For yet another further implementation, the UE can apply the current (or existing, or activated, or applied) configuration (e.g., periodicity) of the SMTC to perform measurement (e.g., L1 and/or L3 measurement).
For yet another further implementation, the UE can apply the default (or non-additional) configuration (e.g., periodicity) of the SMTC to perform measurement (e.g., L1 and/or L3 measurement).

For yet another example, from a UE perspective, the UE may not be configured to monitor the DCI format, or the UE is configured but may not need to monitor the DCI format, or the UE could be configured to monitor/receive the DCI format but can ignore the indication on SSB adaptation in the DCI formation, when the UE is in Scenario 3B.
For one further implementation, the UE can apply the current (or existing, or activated, or applied) configuration (e.g., periodicity) for the SSB to perform measurement (e.g., L1 and/or L3 measurement), and/or validation of other signal or channel (e.g., RACH occasion, PUSCH occasion), and/or collision handling of other signal or channel (e.g., PDCCH, PUCCH, PDSCH, PUSCH, SRS, or CRI-RS), and/or rate matching (e.g., PDSCH, or PUSCH).
For another further implementation, the UE can apply the default (or non-additional) configuration (e.g., periodicity) for the SSB to perform measurement (e.g., L1 and/or L3 measurement), and/or validation of other signal or channel (e.g., RACH occasion, PUSCH occasion), and/or collision handling of other signal or channel (e.g., PDCCH, PUCCH, PDSCH, PUSCH, SRS, or CRI-RS), and/or rate matching (e.g., PDSCH, or PUSCH).
For yet another further implementation, the UE can apply the current (or existing, or activated, or applied) configuration (e.g., periodicity) of the SMTC to perform measurement (e.g., L1 and/or L3 measurement).
For yet another further implementation, the UE can apply the default (or non-additional) configuration (e.g., periodicity) of the SMTC to perform measurement (e.g., L1 and/or L3 measurement).

In the present disclosure, a UE procedure for receiving the DCI format is provided.

In one embodiment, a UE can be provided with a Type3-PDCCH common search space (CSS) set to monitor PDCCH for detection of the DCI format. For one example, the DCI format can be monitored in a PCell only. For another example, the DCI format can be monitored in a PCell or a PScell. For yet another example, the DCI format can be monitored in any cell, such as at least one of a PCell, a SCell, or a PScell.

For one example, the DCI format is monitored during an active time, e.g., of the corresponding serving cell or group of serving cell.
For one further implementation, the active time can be associated with the cell DTX operation, e.g., when cell DTX operation is configured and/or activated.
For another further implementation, the active time can be associated with the cell DRX operation, e.g., when cell DRX operation is configured and/or activated.
For yet another further implementation, the active time can be associated with the C-DRX operation, e.g., when the C-DRX operation is configured and/or activated.

For another example, the DCI format is monitored during both active and inactive time, e.g., of the corresponding serving cell or group of serving cell.
For one further implementation, the active time can be associated with the cell DTX operation, e.g., when cell DTX operation is configured and/or activated.
For another further implementation, the active time can be associated with the cell DRX operation, e.g., when cell DRX operation is configured and/or activated.
For yet another further implementation, the active time can be associated with the C-DRX operation, e.g., when the C-DRX operation is configured and/or activated.

For yet another example, if a higher layer parameter (e.g., a parameter related to SSB adaptation operation such as additional periodicity, or an explicit indication on whether SSB adaptation operation is activated, or an indication/activation of cell DTX operation or cell DRX operation or C-DRX operation) is configured, the DCI format is monitored during active and inactive time; otherwise, the DCI format is monitored during active time, e.g., of the corresponding serving cell or group of serving cell.
For one further implementation, the active time can be associated with the cell DTX operation, e.g., when cell DTX operation is configured and/or activated.
For another further implementation, the active time can be associated with the cell DRX operation, e.g., when cell DRX operation is configured and/or activated.
For yet another further implementation, the active time can be associated with the C-DRX operation, e.g., when the C-DRX operation is configured and/or activated.

For one example, if the DCI format indicates a change of the SSB configuration (e.g., periodicity), the UE can assume the new configuration is valid for a time duration of X (or at most for a duration of X).
For one further implementation, X can be in a unit of ms.
For another further implementation, X can be in a unit of slot.
For yet another further implementation, X can be in a unit of frame.
For yet another further implementation, X can be in a unit of a periodicity of the SSB, e.g., after the change/adaptation.
For yet another further implementation, X can be in a unit of a periodicity of the search space for monitoring the DCI format.
For yet another further implementation, X can be in a unit of a duty cycle, e.g., associated with a cell DTX operation, or cell DRX operation, or C-DRX operation.
For yet another further implementation, X can be pre-defined in the specifications for system operation.
For yet another further implementation, X can be configured by the BS, e.g., per cell, or per SSB configuration (e.g., periodicity).
For yet another further implementation, X can be reported by a UE as a UE capability.
For yet another further implementation, X can be indicated by a UE as a preferred value by UE assistant information (UAI).
For yet another further implementation, the example can be applicable when the SSB configuration (e.g., periodicity) after the change/adaptation is an additional/non-default configuration (e.g., periodicity).
For yet another further implementation, the example can be applicable when the SSB periodicity after the change/adaptation is shorter than the SSB periodicity before the change/adaptation.
For yet another further implementation, if a UE receives another DCI format indicating a change of the SSB configuration (e.g., periodicity), the UE can assume an early termination of the time duration of X for the current SSB configuration (e.g., periodicity).
For yet another further implementation, after the time duration of X, the UE can assume to apply the default/non-additional SSB configuration (e.g., periodicity).
For yet another further implementation, after the time duration of X, the UE can assume to apply the SSB configuration (e.g., periodicity) before the adaptation (e.g., before the time duration of X).

In one example, when a UE receives in slot m on the active DL BWP of a serving cell a PDCCH providing the DCI format (e.g., DCI format 2_9) that indicates a change of SSB periodicity of the current serving cell, the UE operates on the serving cell according to the indicated SSB periodicity starting from the first slot on the active DL BWP that does not begin before the beginning of the slot m+d on the active DL BWP of the serving cell where d is a number of slots for the subcarrier spacing (SCS) of the active DL BWP of the serving cell, and d is the minimum time gap (e.g., processing delay time) determined based on the SCS.

In another example, when a UE receives in slot m on the active DL BWP of a serving cell a PDCCH providing the DCI format (e.g., DCI format 2_9) that indicates a change of SSB periodicity of the current serving cell, the UE operates on the serving cell according to the indicated SSB periodicity starting from the first slot on the active DL BWP that satisfies both the following two conditions:
1. The slot does not begin before the beginning of the slot m+d on the active DL BWP of the serving cell where d is a number of slots for the SCS of the active DL BWP of the serving cell, and d is the minimum time gap (e.g., processing delay time) determined based on the SCS.
2. The beginning of the slot is aligned with the beginning of a periodicity of SSB, wherein the periodicity can be according to one of the following sub-example.
   For a first sub-example, the periodicity equal to the SSB periodicity before the change/adaptation.
   For a second sub-example, the periodicity equal to the SSB periodicity after the change/adaptation (e.g., the SSB periodicity indicated in the DCI format).
   For a third sub-example, the periodicity equal to the minimum of SSB periodicity before the change/adaptation and SSB periodicity after the change/adaptation.
   For a fourth sub-example, the periodicity equal to the maximum of SSB periodicity before the change/adaptation and SSB periodicity after the change/adaptation.

In yet another example, when a UE receives in slot m on the active DL BWP of a serving cell a PDCCH providing the DCI format (e.g., DCI format 2_9) that indicates a change of SSB periodicity of the current serving cell, the UE operates on the serving cell according to the indicated SSB periodicity starting from the (first) slot on the active DL BWP that satisfies at least one of the following conditions:
1. The beginning of the slot m_start is aligned with the beginning of a periodicity of SSB, wherein the periodicity can be according to one of the following sub-example.
   For a first sub-example, the periodicity equal to the SSB periodicity before the change/adaptation.
   For a second sub-example, the periodicity equal to the SSB periodicity after the change/adaptation (e.g., the SSB periodicity indicated in the DCI format).
   For a third sub-example, the periodicity equal to the minimum of SSB periodicity before the change/adaptation and SSB periodicity after the change/adaptation.
   For a fourth sub-example, the periodicity equal to the maximum of SSB periodicity before the change/adaptation and SSB periodicity after the change/adaptation.
2. The (first) slot (e.g., no earlier than slot m_start), which includes candidate SSB occasion corresponding to a first transmitted (candidate) SSB in a (first) SSB burst (e.g., or a (first) half frame) based on the indicated SSB periodicity (e.g., after slot m or after slot m+d), does not begin before the beginning of the slot m+d on the active DL BWP of the serving cell, where d is a number of slots for the SCS of the active DL BWP of the serving cell, and d is the minimum time gap (e.g., processing delay time) determined based on the SCS.
3. The (first) SSB burst (e.g., the first half frame) is within the half frames including SSB transmission or window for measurement, e.g., which has a nesting structure before and after adaptation. For instance, the half frames associated with a longer periodicity is a subset of the half frames associated with a shorter periodicity. For another instance, the value of (2*0+H) mod (P_min/5) is same before and after adaptation, wherein O is the SFN offset (e.g., with respect to SFN #0 or with respect to the start of the period given by the indicated periodicity), H is the half frame index (e.g., within the frame determined by the SFN offset), P_min is the smaller periodicity between the periodicities before and after adaptation in a unit of ms. For one further implementation, the values of O and H can be configured by higher layer parameters and associated with a configuration of the periodicity (e.g., at least for an additional periodicity). For another further implementation, the values of O and H can be determined by a configuration of the window for measurement. For yet another further implementation, the values of O and H can be determined by the UE, e.g., based on the detection of SSB, which is at least applicable for the default periodicity (e.g., ssb-periodicityServingCell (e.g., in servingCellConfigCommon)).

In one example, when a UE receives in slot m on the active DL BWP of a first serving cell a PDCCH providing the DCI format (e.g., DCI format 2_9) that indicates a change of SSB periodicity of a second serving cell, the UE operates on the second serving cell according to the indicated SSB periodicity starting from the first slot on the active DL BWP that does not begin before the beginning of the slot m+d on the active DL BWP of the second serving cell, where d is a number of slots for the SCS of the active DL BWP of the second serving cell, and d is the minimum time gap (e.g., processing delay time) determined based on the SCS.

In another example, when a UE receives in slot m on the active DL BWP of a first serving cell a PDCCH providing the DCI format (e.g., DCI format 2_9) that indicates a change of SSB periodicity of a second serving cell, the UE operates on the second serving cell according to the indicated SSB periodicity starting from the (first) slot that satisfies at least one of the following conditions:
1. The slot does not begin before the beginning of the slot m+d on the active DL BWP of the first serving cell, where d is a number of slots for the SCS of the active DL BWP of the first serving cell, and d is the minimum time gap (e.g., processing delay time) determined based on the SCS of the active DL BWP of the first serving cell.
2. The beginning of the slot is aligned with the beginning of a periodicity of SSB, wherein the periodicity can be according to one of the following sub-example.
   For a first sub-example, the periodicity equal to the SSB periodicity before the change/adaptation.
   For a second sub-example, the periodicity equal to the SSB periodicity after the change/adaptation (e.g., the SSB periodicity indicated in the DCI format).
   For a third sub-example, the periodicity equal to the minimum of SSB periodicity before the change/adaptation and SSB periodicity after the change/adaptation.
   For a fourth sub-example, the periodicity equal to the maximum of SSB periodicity before the change/adaptation and SSB periodicity after the change/adaptation.
3. The half frames including SSB transmission or window for measurement has a nesting structure before and after adaptation. For instance, the half frames associated with a longer periodicity is a subset of the half frames associated with a shorter periodicity. For another instance, the value of (2*O+H) mod (P_min/5) is same before and after adaptation, wherein O is the SFN offset (e.g., with respect to SFN #0 or with respect to the start of the period given by the indicated periodicity), H is the half frame index (e.g., within the frame determined by the SFN offset), P_min is the smaller periodicity between the periodicities before and after adaptation in a unit of ms. For one further implementation, the values of O and H can be configured by higher layer parameter and associated with a configuration of the periodicity (e.g., at least for an additional periodicity). For another further implementation, the values of O and H can be determined by a configuration of the window for measurement. For yet another further implementation, the values of O and H can be determined by the UE, e.g., based on the detection of SSB, which is at least applicable for the default periodicity (e.g., ssb-periodicityServingCell (e.g., in servingCellConfigCommon)).

In yet another example, when a UE receives in slot m on the active DL BWP of a first serving cell a PDCCH providing the DCI format (e.g., DCI format 2_9) that indicates a change of SSB periodicity of a second serving cell, the UE operates on the second serving cell according to the indicated SSB periodicity starting from the (first) slot that satisfies at least one of the following conditions:
1. The beginning of the slot m_start is aligned with the beginning of a periodicity of SSB, wherein the periodicity can be according to one of the following sub-example.
   For a first sub-example, the periodicity equal to the SSB periodicity before the change/adaptation.
   For a second sub-example, the periodicity equal to the SSB periodicity after the change/adaptation (e.g., the SSB periodicity indicated in the DCI format).
   For a third sub-example, the periodicity equal to the minimum of SSB periodicity before the change/adaptation and SSB periodicity after the change/adaptation.
   For a fourth sub-example, the periodicity equal to the maximum of SSB periodicity before the change/adaptation and SSB periodicity after the change/adaptation.
2. The (first) slot (e.g., no earlier than the slot m_start), which includes candidate SSB occasion corresponding to a first transmitted (candidate) SSB in a (first) SSB burst (e.g., or a (first) half frame) based on the indicated SSB periodicity (e.g., after slot m or after slot m+d), does not begin before the beginning of the slot m+d on the active DL BWP of the first serving cell, where d is a number of slots for the SCS of the active DL BWP of the first serving cell, and d is the minimum time gap determined based on the SCS of the active DL BWP of the first serving cell.
3. The (first) SSB burst (e.g., the first half frame) is within the half frames including SSB transmission or window for measurement, e.g., which has a nesting structure before and after adaptation. For instance, the half frames associated with a longer periodicity is a subset of the half frames associated with a shorter periodicity. For another instance, the value of (2*O+H) mod (P_min/5) is same before and after adaptation, wherein O is the SFN offset (e.g., with respect to SFN #0 or with respect to the start of the period given by the indicated periodicity), H is the half frame index (e.g., within the frame determined by the SFN offset), P_min is the smaller periodicity between the periodicities before and after adaptation in a unit of ms. For one further implementation, the values of O and H can be configured by higher layer parameter and associated with a configuration of the periodicity (e.g., at least for an additional periodicity). For another further implementation, the values of O and H can be determined by a configuration of the window for measurement. For yet another further implementation, the values of O and H can be determined by the UE, e.g., based on the detection of SSB, which is at least applicable for the default periodicity (e.g., ssb-periodicityServingCell (e.g., in servingCellConfigCommon)).

In one example, when a UE receives in slot m on the active DL BWP of a first serving cell a PDCCH providing the DCI format (e.g., DCI format 2_9) that indicates a change of SSB periodicity of a second serving cell, the UE operates on the second serving cell according to the indicated SSB periodicity starting from the first slot on the active DL BWP that does not begin before the beginning of the slot └(m+d)·2^{μ1}/2^{μ2}┘ on the active DL BWP of the second serving cell, where d is a number of slots for the SCS of the active DL BWP of the first serving cell, d is the minimum time gap (e.g., processing delay time) determined based on the SCS, μ1 is the SCS of the active DL BWP of the first serving cell, and μ² is the SCS of the active DL BWP of the second serving cell.

In another example, when a UE receives in slot m on the active DL BWP of a first serving cell a PDCCH providing the DCI format (e.g., DCI format 2_9) that indicates a change of SSB periodicity of a second serving cell, the UE operates on the second serving cell according to the indicated SSB periodicity starting from the (first) slot that satisfies at least one of the following conditions:
1. The slot does not begin before the beginning of the slot └(m+d)·2^{μ1}/2²┘ on the active DL BWP of the second serving cell, where d is a number of slots for the SCS of the active DL BWP of the first serving cell, d is the minimum time gap determined based on the SCS, μ1 is the SCS of the active DL BWP of the first serving cell, and μ2 is the SCS of the active DL BWP of the second serving cell.
2. The beginning of the slot is aligned with the beginning of a periodicity of SSB, wherein the periodicity can be according to one of the following sub-example.
   For a first sub-example, the periodicity equal to the SSB periodicity before the change/adaptation.
   For a second sub-example, the periodicity equal to the SSB periodicity after the change/adaptation (e.g., the SSB periodicity indicated in the DCI format).
   For a third sub-example, the periodicity equal to the minimum of SSB periodicity before the change/adaptation and SSB periodicity after the change/adaptation.
   For a fourth sub-example, the periodicity equal to the maximum of SSB periodicity before the change/adaptation and SSB periodicity after the change/adaptation.

In another example, when a UE receives in slot m on the active DL BWP of a first serving cell a PDCCH providing the DCI format (e.g., DCI format 2_9) that indicates a change of SSB periodicity of a second serving cell, the UE operates on the second serving cell according to the indicated SSB periodicity starting from the (first) slot that satisfies at least one of the following conditions:
1. The beginning of the slot m_start is aligned with the beginning of a periodicity of SSB, wherein the periodicity can be according to one of the following sub-example.
   For a first sub-example, the periodicity equal to the SSB periodicity before the change/adaptation.
   For a second sub-example, the periodicity equal to the SSB periodicity after the change/adaptation (e.g., the SSB periodicity indicated in the DCI format).
   For a third sub-example, the periodicity equal to the minimum of SSB periodicity before the change/adaptation and SSB periodicity after the change/adaptation.
   For a fourth sub-example, the periodicity equal to the maximum of SSB periodicity before the change/adaptation and SSB periodicity after the change/adaptation.
2. The (first) slot (e.g., no earlier than slot m_start), which includes candidate SSB occasion corresponding to a first transmitted (candidate) SSB in a (first) SSB burst (e.g., or a (first) half frame) based on the indicated SSB periodicity (e.g., after slot m or after slot m+d), does not begin before the beginning of the slot └(m+d)·2^{μ1}/2^{μ2}┘ on the active DL BWP of the second serving cell, where d is a number of slots for the SCS of the active DL BWP of the first serving cell, d is the minimum time gap determined based on the SCS, μ1 is the SCS of the active DL BWP of the first serving cell, and μ² is the SCS of the active DL BWP of the second serving cell.
3. The (first) SSB burst (e.g., the first half frame) is within the half frames including SSB transmission or window for measurement, which has a nesting structure before and after adaptation. For instance, the half frames associated with a longer periodicity is a subset of the half frames associated with a shorter periodicity. For another instance, the value of (2*O+H) mod (P_min/5) is same before and after adaptation, wherein O is the SFN offset (e.g., with respect to SFN #0 or with respect to the start of the period given by the indicated periodicity), H is the half frame index (e.g., within the frame determined by the SFN offset), P_min is the smaller periodicity between the periodicities before and after adaptation in a unit of ms. For one further implementation, the values of O and H can be configured by higher layer parameter and associated with a configuration of the periodicity (e.g., at least for an additional periodicity). For another further implementation, the values of O and H can be determined by a configuration of the window for measurement. For yet another further implementation, the values of O and H can be determined by the UE, e.g., based on the detection of SSB, which is at least applicable for the default periodicity (e.g., ssb-periodicityServingCell (e.g., in servingCellConfigCommon)).

For one further implementation of above examples, d can be determined based on Table 1 below.

TABLE 1
Value of d based on SCS

| SCS (kHz) | d as number of slots |
|---|---|
| 15 | 3 |
| 30 | 6 |
| 60 | 12 |
| 120 | 24 |
| 480 | 96 |
| 960 | 192 |

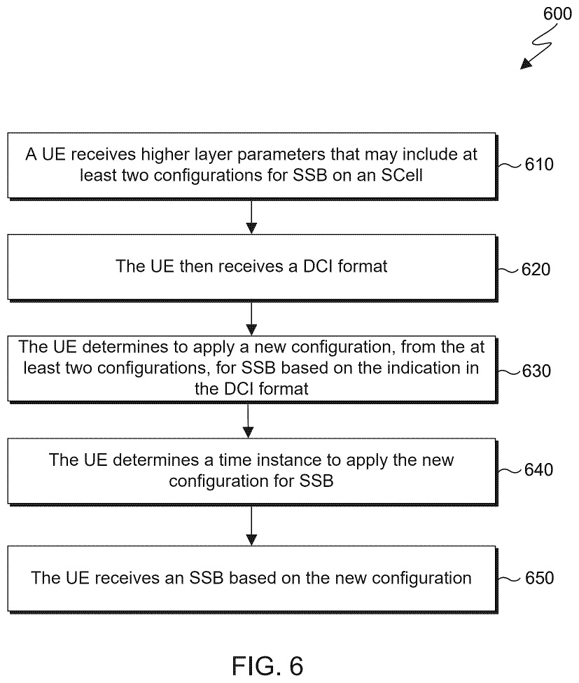

FIG. 6 illustrates an example method 600 per ormed by a UE in a wireless communication system according to embodiments of the present disclosure. More particularly, FIG. 6 illustrates an example UE procedure for adapting SSB configuration based on a DCI format. The method 600 of FIG. 6 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 600 is for illustration only and other embodiments can be used without departing from the scope of the present disclosure.

The method 600 begins with the UE receiving higher layer parameters that may include at least two configurations for SSB on an SCell (610). The UE then receives a DCI format (620). After receiving the DCI format, the UE then determines to apply a new configuration, from the at least two configurations, for SSB based on the indication in the DCI format (630). The UE then determines a time instance to apply the new configuration for SSB (640). Once determined, the UE then receives an SSB based on the new configuration (650).

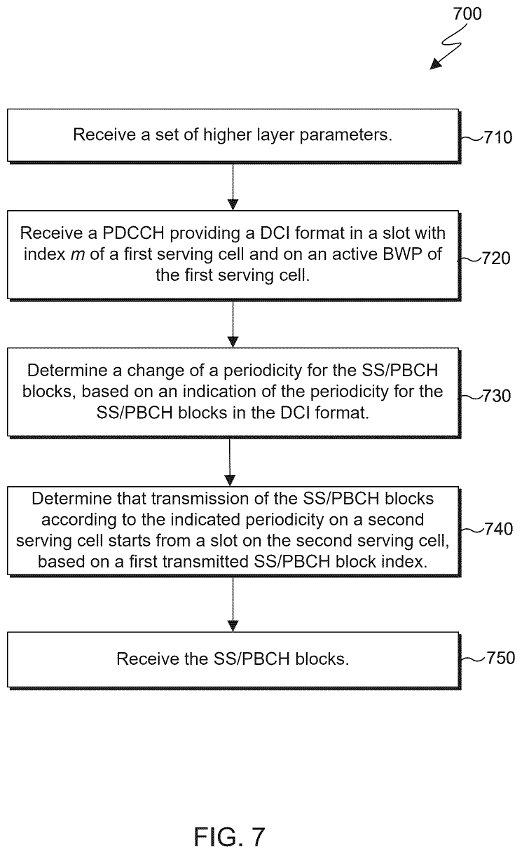

FIG. 7 illustrates an example method 700 performed by a UE in a wireless communication system according to embodiments of the present disclosure. The method 700 of FIG. 7 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 700 is for illustration only and other embodiments can be used without departing from the scope of the present disclosure.

The method 700 begins with the UE receiving a set of higher layer parameters (710). For example, in 710, the set of higher layer parameters includes a first periodicity for SS/PBCH blocks and a set of additional periodicities for the SS/PBCH blocks. The UE then receives a PDCCH providing a DCI format in a slot with index m of a first serving cell and on an active BWP of the first serving cell (720).

The UE then determines a change of a periodicity for the SS/PBCH blocks, based on an indication of the periodicity for the SS/PBCH blocks in the DCI format (730). The UE then determines that transmission of the SS/PBCH blocks according to the indicated periodicity on a second serving cell starts from a slot on the second serving cell, based on a first transmitted SS/PBCH block index (740). The UE then receives the SS/PBCH blocks (750).

In various embodiments, the slot on the second serving cell is a first slot that includes a candidate SS/PBCH block occasion corresponding to the first transmitted SS/PBCH block index in a first half frame with the indicated periodicity. The slot on the second serving cell does not begin before a beginning of a slot with index m+d on the active downlink BWP of the first serving cell.

In various embodiments, the first half frame is within a first set of half frames given by a SFN offset and a half frame index when the indicated periodicity is from the set of additional periodicities or within a second set of half frames determined by the UE when the indicated periodicity is the first periodicity. The SFN offset and the half frame index are included in the set of higher layer parameters. In various embodiments, d is a number of slots according to a SCS of the active downlink BWP of the first serving cell. When the SCS is 15 kHz, d is 3. When the SCS is 30 kHz, d is 6. When the SCS is 60 kHz, d is 12. When the SCS is 120 kHz, d is 24. When the SCS is 480 kHz, d is 96. When the SCS is 960 kHz, d is 192.

In various embodiments, the PDCCH is monitored in a Type3-PDCCH CSS set, and the DCI format is a DCI format 2_9 with a CRC scrambled by a RNTI dedicated for an adaptation of the periodicity for the SS/PBCH blocks.

In various embodiments, the DCI format includes a number of blocks. A block in the number of blocks includes the indication of the periodicity. A number of bits for the block is given by ┌log 2(1+K)┐, where K is a number of additional periodicities in the set of additional periodicities. A location of the block is included in the set of higher layer parameters.

In various embodiments, the indicated periodicity is determined as the first periodicity when the indication in the DCI format takes a first value, a first additional periodicity in the set of additional periodicities when the indication in the DCI format takes a second value, or a second additional periodicity in the set of additional periodicities when the indication in the DCI format takes a third value.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to:
receive a set of higher layer parameters, the set of higher layer parameters including:
a first periodicity for synchronization signals and physical broadcast channel (SS/PBCH) blocks, and
a set of additional periodicities for the SS/PBCH blocks; and
receive a physical downlink control channel (PDCCH) providing a downlink control information (DCI) format in a slot with index m of a first serving cell and on an active downlink bandwidth part (BWP) of the first serving cell; and
a processor operably coupled to the transceiver, the processor configured to:
determine a change of a periodicity for the SS/PBCH blocks, based on an indication of the periodicity for the SS/PBCH blocks in the DCI format; and
determine that transmission of the SS/PBCH blocks according to the indicated periodicity on a second serving cell starts from a slot on the second serving cell, based on a first transmitted SS/PBCH block index,
wherein the transceiver is further configured to receive the SS/PBCH blocks.

2. The UE of claim 1, wherein:
the slot on the second serving cell is a first slot that includes a candidate SS/PBCH block occasion corresponding to the first transmitted SS/PBCH block index in a first half frame with the indicated periodicity, and
the slot on the second serving cell does not begin before a beginning of a slot with index m+d on the active downlink BWP of the first serving cell.

3. The UE of claim 2, wherein the first half frame is:
within a first set of half frames given by a system frame number (SFN) offset and a half frame index when the indicated periodicity is from the set of additional periodicities, wherein the SFN offset and the half frame index are included in the set of higher layer parameters, or
within a second set of half frames determined by the UE when the indicated periodicity is the first periodicity.

4. The UE of claim 2, wherein:
d is a number of slots according to a subcarrier spacing (SCS) of the active downlink BWP of the first serving cell;
when the SCS is 15 kilohertz (kHz), d is 3;
when the SCS is 30 kHz, d is 6;
when the SCS is 60 kHz, d is 12;
when the SCS is 120 kHz, d is 24;
when the SCS is 480 kHz, d is 96; and
when the SCS is 960 kHz, d is 192.

5. The UE of claim 1, wherein:
the PDCCH is monitored in a Type3-PDCCH common search space (CSS) set, and
the DCI format is a DCI format 2_9 with a cyclic redundancy check (CRC) scrambled by a radio network temporary identifier (RNTI) dedicated for an adaptation of the periodicity for the SS/PBCH blocks.

6. The UE of claim 1, wherein:
the DCI format includes a number of blocks;
a block in the number of blocks includes the indication of the periodicity;
a number of bits for the block is given by ┌log 2(1+K)┐, where K is a number of additional periodicities in the set of additional periodicities; and
a location of the block is included in the set of higher layer parameters.

7. The UE of claim 1, wherein the indicated periodicity is determined as:
the first periodicity when the indication in the DCI format takes a first value,
a first additional periodicity in the set of additional periodicities when the indication in the DCI format takes a second value, or
a second additional periodicity in the set of additional periodicities when the indication in the DCI format takes a third value.

8. A method of a user equipment (UE) in a wireless communication system, the method comprising:
receiving a set of higher layer parameters, the set of higher layer parameters including:
a first periodicity for synchronization signals and physical broadcast channel (SS/PBCH) blocks, and
a set of additional periodicities for the SS/PBCH blocks;
receiving a physical downlink control channel (PDCCH) providing a downlink control information (DCI) format in a slot with index m of a first serving cell and on an active downlink bandwidth part (BWP) of the first serving cell;
determining a change of a periodicity for the SS/PBCH blocks, based on an indication of the periodicity for the SS/PBCH blocks in the DCI format;
determining that transmission of the SS/PBCH blocks according to the indicated periodicity on a second serving cell starts from a slot on the second serving cell, based on a first transmitted SS/PBCH block index; and
receiving the SS/PBCH blocks.

9. The method of claim 8, wherein:
the slot on the second serving cell is a first slot that includes a candidate SS/PBCH block occasion corresponding to the first transmitted SS/PBCH block index in a first half frame with the indicated periodicity, and
the slot on the second serving cell does not begin before a beginning of a slot with index m+d on the active downlink BWP of the first serving cell.

10. The method of claim 9, wherein the first half frame is:
within a first set of half frames given by a system frame number (SFN) offset and a half frame index when the indicated periodicity is from the set of additional periodicities, wherein the SFN offset and the half frame index are included in the set of higher layer parameters, or
within a second set of half frames determined by the UE when the indicated periodicity is the first periodicity.

11. The method of claim 8, wherein:
d is a number of slots according to a subcarrier spacing (SCS) of the active downlink BWP of the first serving cell;
when the SCS is 15 kilohertz (kHz), d is 3;
when the SCS is 30 kHz, d is 6;
when the SCS is 60 kHz, d is 12;
when the SCS is 120 kHz, d is 24;
when the SCS is 480 kHz, d is 96; and
when the SCS is 960 kHz, d is 192.

12. The method of claim 8, wherein:
the PDCCH is monitored in a Type3-PDCCH common search space (CSS) set, and
the DCI format is a DCI format 2_9 with a cyclic redundancy check (CRC) scrambled by a radio network temporary identifier (RNTI) dedicated for an adaptation of the periodicity for the SS/PBCH blocks.

13. The method of claim 8, wherein:
the DCI format includes a number of blocks;
a block in the number of blocks includes the indication of the periodicity;
a number of bits for the block is given by ┌log 2(1+K)┐, where K is a number of additional periodicities in the set of additional periodicities; and
a location of the block is included in the set of higher layer parameters.

14. The method of claim 8, wherein the indicated periodicity is determined as:
the first periodicity when the indication in the DCI format takes a first value,
a first additional periodicity in the set of additional periodicities when the indication in the DCI format takes a second value, or
a second additional periodicity in the set of additional periodicities when the indication in the DCI format takes a third value.

15. A base station (BS) in a wireless communication system, the BS comprising:
a transceiver configured to:
transmit a set of higher layer parameters, the set of higher layer parameters including:
a first periodicity for synchronization signals and physical broadcast channel (SS/PBCH) blocks, and
a set of additional periodicities for the SS/PBCH blocks; and
transmit a physical downlink control channel (PDCCH) providing a downlink control information (DCI) format in a slot with index m of a first serving cell and on an active downlink bandwidth part (BWP) of the first serving cell; and
a processor operably coupled to the transceiver, the processor configured to:
determine a change of a periodicity for the SS/PBCH blocks, based on an indication of the periodicity for the SS/PBCH blocks in the DCI format; and
determine that transmission of the SS/PBCH blocks according to the indicated periodicity on a second serving cell starts from a slot on the second serving cell, based on a first transmitted SS/PBCH block index,
wherein the transceiver is further configured to transmit the SS/PBCH blocks.

16. The BS of claim 15, wherein:
the slot on the second serving cell is a first slot that includes a candidate SS/PBCH block occasion corresponding to the first transmitted SS/PBCH block index in a first half frame with the indicated periodicity;
the slot on the second serving cell does not begin before a beginning of a slot with index m+d on the active downlink BWP of the first serving cell; and
the first half frame is:
within a first set of half frames given by a system frame number (SFN) offset and a half frame index when the indicated periodicity is from the set of additional periodicities, wherein the SFN offset and the half frame index are included in the set of higher layer parameters, or
within a second set of half frames determined by a user equipment (UE) when the indicated periodicity is the first periodicity.

17. The BS of claim 15, wherein:
d is a number of slots according to a subcarrier spacing (SCS) of the active downlink BWP of the first serving cell;
when the SCS is 15 kilohertz (kHz), d is 3;
when the SCS is 30 kHz, d is 6;
when the SCS is 60 kHz, d is 12;
when the SCS is 120 kHz, d is 24;
when the SCS is 480 kHz, d is 96; and
when the SCS is 960 kHz, d is 192.

18. The BS of claim 15, wherein:
the PDCCH is monitored in a Type3-PDCCH common search space (CSS) set, and
the DCI format is a DCI format 2_9 with a cyclic redundancy check (CRC) scrambled by a radio network temporary identifier (RNTI) dedicated for an adaptation of the periodicity for the SS/PBCH blocks.

19. The BS of claim 15, wherein:
the DCI format includes a number of blocks;
a block in the number of blocks includes the indication of the periodicity;
a number of bits for the block is given by ┌log 2(1+K)┐, where K is a number of additional periodicities in the set of additional periodicities; and
a location of the block is included in the set of higher layer parameters.

20. The BS of claim 15, wherein the indicated periodicity is determined as:
the first periodicity when the indication in the DCI format takes a first value,
a first additional periodicity in the set of additional periodicities when the indication in the DCI format takes a second value, or
a second additional periodicity in the set of additional periodicities when the indication in the DCI format takes a third value.
